(19) United States
(12) Patent Application Publication
(10) Pub. No.: US 2010/0148932 A1
(43) Pub. Date: Jun. 17, 2010

(54) WIRELESS ELECTRONIC ARTICLE SURVEILLANCE SYNCHRONIZATION SYSTEM AND METHOD WITH DATA TRANSFER

(75) Inventor: Jeffrey T. Oakes, Boca Raton, FL (US)

Correspondence Address: Christopher & Weisberg, P.A., 200 East Las Olas Boulevard, Suite 2040, Fort Lauderdale, FL, 33301, US

(73) Assignee: Sensormatic Electronics Corporation, Boca Raton, FL (US)

(21) Appl. No.: 12/336,658

(22) Filed: Dec. 17, 2008

(51) Int. Cl. H04Q 5/22

(52) U.S. Cl. 340/10.2

(57) ABSTRACT

A method and system are provided for synchronizing a plurality of electronic article surveillance (“EAS”) units and providing wireless data transfer by the EAS units. The invention generates a master synchronization signal, transmits the master synchronization signal to the plurality of EAS units and applies the master synchronization signal to trigger a synchronization packet reception period. A beginning of a wireless data transfer period is calculated and initiated based on the triggering of the synchronization packet reception period.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to a method and system for electronic article surveillance device communication and in particular to a method and system for wirelessly synchronizing the timing of these devices while also allowing data communication among the devices.

### BACKGROUND OF THE INVENTION

Electronic article surveillance (“EAS”) systems are used to protect articles from unauthorized removal from a protected area. Such systems typically operate using a tag (also referred to as a “label”) affixed to the article being protected. The tags are arranged such that, when activated, the tags respond to an interrogation signal in a predictable manner, thereby allowing the interrogating device, e.g., reader, to determine that an active tag is in the interrogation zone. For example, an interrogation zone may be established near the exit of a store so that articles with activated tags trigger an alarm when detected by the reader. The tags can be deactivated by a deactivator so that they do not respond to the interrogation signal or respond in some other manner indicative of a deactivated tag. Such deactivation is typically performed at a point of transaction area where a customer has properly purchased the article.

Many EAS systems, such as magneto-acoustic EAS systems operate by periodically transmitting an interrogation signal which stimulates the magneto-acoustic tag to induce a responsive signal. The EAS system then stops transmitting and awaits receipt of the responsive signal. In other words, there is a period of interrogation signal transmission followed by a period of no interrogation signal transmission so that the reader can “listen” for responsive signals from the tags that may be in the interrogation zone.

While such an arrangement functions sufficiently for implementations having a single interrogating device, large installations typically use more than one interrogation device to establish multiple interrogation zones. As but one example, a shopping mall may have many EAS systems that are installed among the several stores. In order to avoid interference among the several EAS systems, the interrogation signals transmitted among the several EAS systems are synchronized. For example, the EAS systems may be synchronized so that one EAS system is not falsely triggered by detecting the transmitted interrogation signal from an adjacent EAS system and interpreting this detection as an activated tag.

A master timing source is typically employed to synchronize EAS systems to one another. In installations where there is a reliable AC power source, such as in the U.S. and other developed nations, EAS systems may use the zero crossing of a common AC line signal as a point for synchronization. However, in installations where there is no reliable AC power source, such as a case where multiple independent generators are used to provide multiple independent AC power sources, the multiple independent AC power sources may not be used to synchronize a plurality of EAS systems. Accordingly, there is a need for methods and systems of synchronizing a plurality of EAS systems that are coupled to multiple independent AC power sources.

There is also a need for the plurality of EAS systems to communicate with one another to share collected data, e.g., alarm information, people counters, etc. Rather than adding complexity and inefficiency to these EAS systems through the implementation of protocols that detract from the interrogation function of the devices, it is desirable to have a method and system that provides an integrated mechanism that provides both synchronization and data transfer among several EAS systems.

### SUMMARY OF THE INVENTION

The present invention advantageously provides a method and system for synchronizing a plurality of electronic article surveillance (“EAS”) units and providing wireless data transfer by the EAS units. The invention generates a master synchronization signal, transmits the master synchronization signal to the plurality of EAS units and applies the master synchronization signal to trigger a synchronization packet reception period. A beginning of a wireless data transfer period is calculated and initiated based on the triggering of the synchronization packet reception period.

In accordance with another aspect, the present invention provides a system for synchronizing the operation of a plurality of EAS units and providing wireless data transfer by the EAS units. The system includes a synchronization master having a master phase-locked loop generating a master synchronization signal, a master radio transmitter transmitting the master synchronization signal, and a master radio receiver receiving data originating from the EAS units.

In accordance with yet another aspect, the present invention provides an EAS system having a repeater receiving a synchronization signal and generating a pattern of receiving time periods and transmitting time periods based on the synchronization period. The EAS unit is in communication with the repeater, the EAS unit being arranged to communicate during the receiving time periods and the transmitting time periods.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram of a system constructed in accordance with the principles of the present invention;

FIG. 2 illustrates timing diagrams for a power line signal, a phase locked loop signal and electronic article surveillance unit activity based on receiving and transmitting data packets; and

FIG. 3 illustrates timing diagrams for a phase locked loop signal and repeater activity for receiving and transmitting data packets and a timer controlled initiation of data packet reception and packet transmission for the repeaters.

### DETAILED DESCRIPTION OF THE INVENTION

According to one embodiment, the invention provides wireless interrogation methods and systems for detecting items, such as tags, at one or more remote locations and performing actions, such as collecting information from the remote interrogation systems and/or distributing timing information to the remote interrogation systems, among performing other actions. The remote interrogation systems may be positioned at selected locations, such as retail stores, warehouses, or other locations, to monitor tags.

According to one embodiment, the tags may be formed from materials that respond to interrogation fields having a one or more preselected frequencies. For example, active tags may vibrate and generate electromagnetic fields when exposed to preselected frequencies. Alternatively, an electromagnetic field may be applied to deactivate or disable the active tags in order to avoid detection by the interrogation systems. For example, a deactivation system may transmit an interrogation signal that excites the active tag and upon detecting a return signal transmitted from the active tag, the deactivation system may change the magnetic properties of the active tags.

The remote interrogation systems generate high strength signals relative to tags, which generate low strength signals. The remote interrogation systems may employ high gain detectors that detect the low strength signals produced by the tags. Additionally, the high gain detectors may detect high strength signals produced from other remote interrogation systems that are positioned outside a relevant interrogation zone.

According to one embodiment, the invention applies timing information to synchronize data transmission and reception by the remote interrogation systems. During designated reception periods, the remote interrogation systems stop transmitting signals and the active tags continue transmitting low strength signals at the interrogation frequency. If active tag signals are detected within the relevant interrogation zones during the designated reception periods, then an alert may be generated. For example, an audible alarm may be triggered when an active tag signal is detected during the designated reception periods.

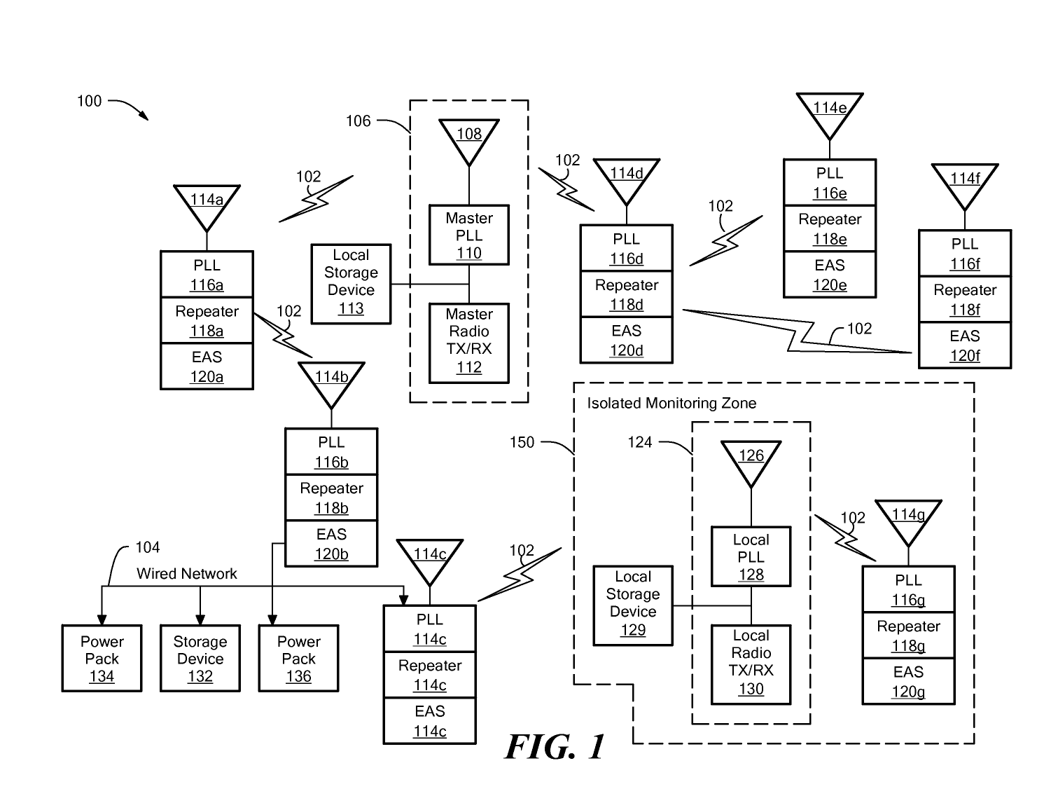

Referring now to the drawing figures in which like reference designators refer to like elements, there is shown in FIG. 1 a diagram of an exemplary system constructed in accordance with the principles of the present invention and designated generally as “100”. The system 100 includes various components that may be connected via wireless media 102, wired media 104 or a combination of both.

According to one embodiment, the invention includes a synchronization master radio 106 and a plurality of remote devices that are constructed in accordance with the teachings discussed below. The synchronization master radio 106 may include components, such as a master antenna 108, a master phase locked loop (“PLL”) 110, a master radio transmitter/receiver 112 and a master storage device 113, among other components. The master storage device 113 may be implemented using a personal computer or other device. The master antenna 108 is coupled to the master radio transmit/receive 112 and transmits the packet signal or exciter pulse.

The remote devices may include components, such as antennas 114a-114f, phase locked loops 116a-116f, repeaters 118a-118f, and electronic article surveillance (“EAS”) units 120a-120f, among other components. The antennas 114a-114g are coupled to the repeaters 118a-118g and the EAS units for transmitting the packet signal or exciter pulse and for receiving a characteristic response of an excited marker or tag. While the remote devices are illustrated having a single repeater and EAS unit, one of ordinary skill in the art readily appreciates that the invention may be implemented with plurality of EAS units coupled to a repeater.

According to one embodiment, the synchronization master radio 106 may communicate directly or indirectly with the repeaters 118a-118f and/or the EAS units 120a-120f Additionally, the repeaters 118a-118f and the EAS units 120a-120f may communicate directly or indirectly with other devices, such as one or more storage devices 132, among other devices. The storage devices 132 may be implemented using personal computers or other devices. For example, if the repeaters 118a-118f and/or the EAS units 120a-120f are positioned within a signal range of the synchronization master radio 106, then these devices may communicate directly with the synchronization master radio 106. Otherwise, if the repeaters 118a-118f and/or the EAS units 120a-120f are positioned outside a signal range of the synchronization master radio 106, then these devices may communicate indirectly with the synchronization master radio 106 through the repeaters 118a-118f and/or the other EAS units 120a-120f that are positioned within a signal range of the synchronization master radio 106. By providing indirect communication capabilities, the present invention enables forming long networks of repeaters and/or EAS units that are controlled by the synchronization master radio 106.

According to one embodiment, the system 100 may include isolated monitoring zones. An isolated monitoring zone 150 may include a local master radio 124 that detects a signal transmitted by the synchronization master radio 106. The local master radio 124 may communicate with the synchronization master radio 106 via wired media 104 and/or wireless media 102. The local master radio 124 may include components, such as a local master antenna 126, a local phase locked loop 128, a local storage device 129 and a local master transmitter/receiver 130, among other components. The local storage device 129 may be implemented using a personal computer or other device.

According to one embodiment, the local master radio 124 may be configured to transmit the synchronization signals to remote devices within an isolated monitoring zone, such as the EAS unit 120g and/or other remote devices. The local master radio 124 may be configured to communicate with remote devices that are not able to detect the synchronization signal transmitted by the synchronization master radio 106. For example, the remote devices may be shielded from the synchronization master radio 106, may be located outside a broadcast range of the synchronization master radio 106, or may be unable to communicate with the synchronization master terminal 106 for other reasons.

According to one embodiment, the local master radio 124 may include hardware, such as a local PLL 128, that phase-locks to a signal originating directly from the synchronization master radio 106. Alternatively, the local PLL 128 may phase-lock to a signal that originates indirectly from the synchronization master radio 106, for example, a signal that is propagated by one or more repeaters 118a-118f. The local master radio 124 may relay the synchronization signal to the remote systems without introducing a substantial delay. The local master radio 124 may introduce a pre-selected delay, e.g., of 1/90 Hz or 1/180 Hz, another multiple of 1/180 Hz or other delay, prior to relaying the synchronization signal to the remote systems. The local master radio 124 may relay the synchronization signal originating from the synchronization master radio 106 when the EAS units 120a-120g are outside a communication range and are not able to communicate with the synchronization master radio 106. The local master radio 124 may introduce a controlled time delay before relaying the synchronization signal generated by the wireless synchronization master radio 106 to the EAS units 120a-120g.

According to one embodiment, the local remote devices may include components such as antennas 114g, phase locked loops 116g, repeaters 118g, and EAS units 120g, among other components. The local master radio 124 may communicate directly or indirectly with the repeaters 118g and/or the EAS units 120g. Additionally, the repeaters 118g and the EAS units 120g may communicate directly or indirectly with other devices, such as one or more local storage devices 129, among other devices. While the local remote devices are illustrated to include a repeater and EAS unit, one of ordinary skill in the art readily appreciates that the invention may be implemented with a repeater coupled to a plurality of EAS units. Additionally, although seven repeaters 118a-118g and seven EAS units 120a-120g are illustrated in FIG. 1, this quantity is merely exemplary and it is understood that fewer or more units may be deployed in accordance with the principles of the present invention.

According to one embodiment, the local master radio 124 may be deployed in isolated monitoring zones, for example, in retail stores located within a shopping mall, inventory warehouses, and/or other areas that need security, among other isolated monitoring zones. The local master radio 124 may receive synchronizing information from the synchronization master radio 106 and may be configured not to transmit data outside the isolated monitoring zone 150. For example, the communication channels within the isolated monitoring zone 150 may be encrypted and/or pre-programmed with a data packet identification scheme that maintains data transfer only within isolated monitoring zone 150.

The synchronization master radio 106 may include a master PLL 110 that generates a synchronization signal, which is transmitted over the wireless media 102. The master radio transmitter/receiver 112 may transmit the synchronization signal to the plurality of repeaters 118a-118g either directly or via the local master radio 124. The synchronization signal may be transmitted on the wired network 104 between repeaters, such as between repeater 118b and repeater 118c. The wired network 104 may be implemented using multi-pair Ethernet type cable. According to one embodiment, the remote devices may be coupled to power packs 134,136 through the wired network 104.

In general, a PLL is a feedback control circuit that synchronizes the phase of a generated signal with that of a reference signal. For example, a PLL operates to lock a desired system frequency to an accurate reference frequency. In the system 100, the master PLL 110 may generate a synchronization signal that is transmitted by the master radio transmitter/receiver 112 to remote devices, such as the repeaters 118a-118f and the local master radio 124, among other remote devices. For example, the synchronization signal may be generated at 50 Hz, 60 Hz or some other frequency. The synchronization master radio 106 may transmit the synchronization signal by various communication link protocols, such as, for example ZigBee, which is the name of a specification for a suite of high level communication protocols using small, low-power digital radios based on the IEEE 802.15.4 standard for wireless personal area networks (“WPANs”), among other communication protocols.

Upon receiving the synchronization signal directly or indirectly from the master PLL 110, the remote PLLs 116a-116g and the local PLL 128 become phase-locked to the master PLL 110. According to one embodiment, the repeaters 118a-118g and the local radio transmitter/receiver 124 synchronize the EAS units 120a-120g to the synchronization master radio 106. While FIG. 1 does not show an EAS unit coupled to the synchronization master radio 106, is it understood that one or more EAS units may be coupled to and supported by the synchronization master radio 106. The EAS units 120a-120g are not shown coupled to the synchronization master radio 106 in FIG. 1 solely for ease of understanding. Furthermore, while FIG. 1 illustrates that the remote devices include separate components for the antenna 114a-114g, the remote PLL 116a-116g, the repeaters 118a-118g and the EAS units 120a-120g, these components may be integrated into fewer components.

According to one embodiment, the system 100 may be used to set interrogation signal synchronization of the EAS units 120a-120g across very broad geographical regions, regardless of whether the EAS units are coupled to a common power source and/or share common power grid frequency, phase drift or quality. The synchronization master radio 106 generates a data packet transmission that is synchronized to the PLL timing. The remote PLLs 116a-116g and the repeaters 118a-118g receive the data packet synchronized with the master PLL 110 and synchronize the EAS units 120a-120g to the start of the data packet reception. Since the signal transmission is instantaneous, there is substantially no delay from the reception start to the transmission start. According to one embodiment, the synchronization timing for the PLLs is triggered by the start of the data packet transmission. The data transmitted in the data packet is captured by the corresponding EAS units 120a-120g. According to one embodiment, the master PLL 110 may be phase locked to a trigger, such as a power line zero crossing or other trigger. The data packets may be sent so that the instant of transmission corresponds to the PLL timing. For example, a downstream repeater may phase lock to the start of the reception of a data packet. The data packet may be transmitted at a predefined delay, such as a 1/180 period or other delay.

According to one embodiment, the repeaters 118a-118g and the local master radio 124 that are located within a communication range of the synchronization master radio 106 may become phase locked to the start of the packet signal, which generates a timing sequence for transmitting synchronization information and data at a controlled instant. The repeaters 118a-118g that are located outside of the communication range of the synchronization master radio 106 may repeat this process upon receiving a delayed timing transmit packet signal from upstream repeaters 118a-118g. The transmission timing of the repeaters 118a-118g is controlled to the same extent as the synchronization master radio 106.

According to the invention, data may flow between the repeaters 118a-118g in both upstream and downstream directions. According to one embodiment, all of the repeaters 118a-118g may be located downstream of the synchronization master radio 106. Any repeater 118a-118g that receives outbound information originating from the direction of the synchronization master radio 106 is downstream of the sending repeater. By contrast, any repeater 118a-118g that is located between a sending repeater and the synchronization master radio 106 is upstream of the sending repeater. Furthermore, data that travels in a direction away from the synchronization master radio 106 is outbound data and data that travels in a direction toward the synchronization master radio 106 is inbound data. The invention defines synchronization information as flowing in a downstream direction among the remote PLLs 116a-116g and the repeaters 118a-118g. According to one embodiment, the synchronization information is transmitted downstream and is independent of data flow direction.

According to the invention, the repeaters 118a-118g may transmit and receive information and/or data on different channels. For example, the repeater 118d may be configured to both receive synchronization timing information from the synchronization master radio 106 and to transmit data to other repeaters 118b-118g on Channel 0. For example, the repeater 118e may be configured to receive the synchronization timing information and the data from the repeater 118d on Channel 0 and to transmit synchronization timing information and data on Channel 3. Additionally, the repeater 118f may be configured to receive the synchronization timing information and the data from the repeater 118d on Channel 0 and to transmit synchronization timing information and data on Channel 5. According to one embodiment, the repeater 118d may be configured to receive data on Channels 3 and 5.

The EAS units 120a-120g may collect data such as a number of alarms generated over a defined time period, a number of tag deactivations performed over a defined time period, a number of people that walk through a preselected area, among other data. The synchronization master radio 106 may poll the EAS units 120a-120g at predefined time periods and the data may be stored at one or more storage devices 113, 129, 132. The data may be communicated over wireless media 102 and/or wired media 104 to various destinations. Additionally, the EAS units 120a-120g and/or the storage devices 113, 129, 132 may be remotely accessed via telephone, Internet or other communication channels to diagnose problems or remotely upgrade software.

According to one embodiment, the EAS units 120a-120g and the storage devices 113, 129, 132 may operate in a polled network response mode. Data requests may be transmitted to the EAS units 120a-120g and/or the storage devices 113, 129, 132 and targeted EAS units 120a-120g and/or targeted storage devices 113, 129, 132 may respond. Alternatively, the synchronization master radio 106 may individually cycle through the EAS units 120a-120g and/or the storage devices 113, 129, 132 and collect data from each in turn.

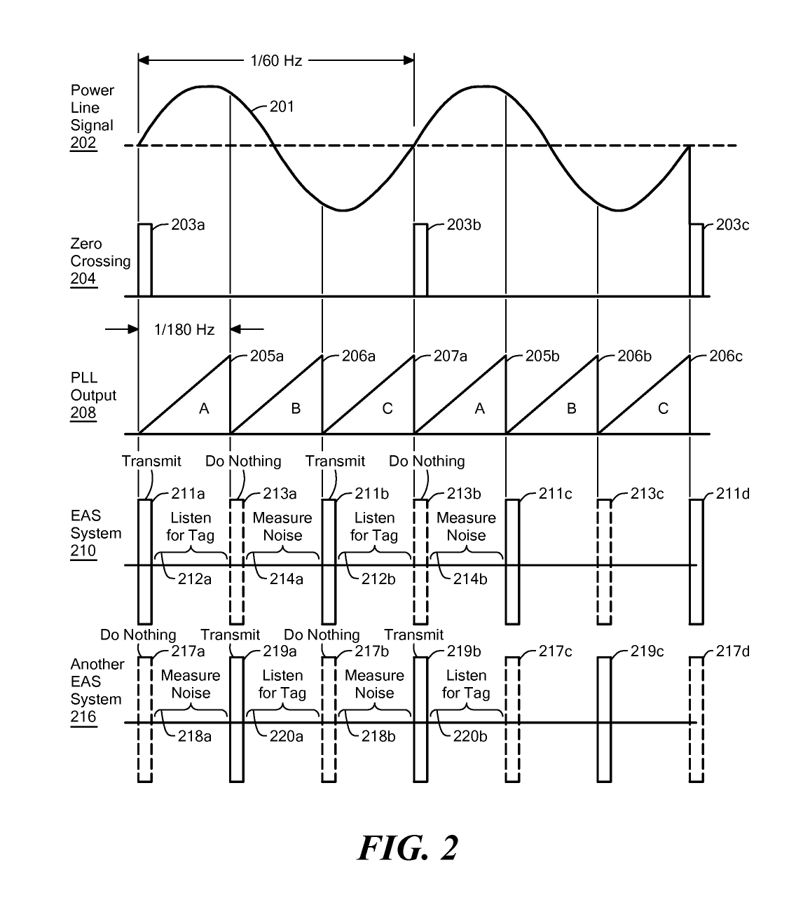

The exemplary system arrangement shown in FIG. 1 provides a way to synchronize the plurality of EAS units 120a-120g while also providing wireless data transfer by the EAS units 120a-120g. A master synchronization signal is generated and transmitted to the plurality of EAS units 120a-120g. The master synchronization signal triggers a synchronization packet reception period and initiates calculation of a wireless data transfer period, based on the triggering of the synchronization packet reception period. A detailed explanation of an exemplary operation of the present invention is described with reference to FIG. 2.

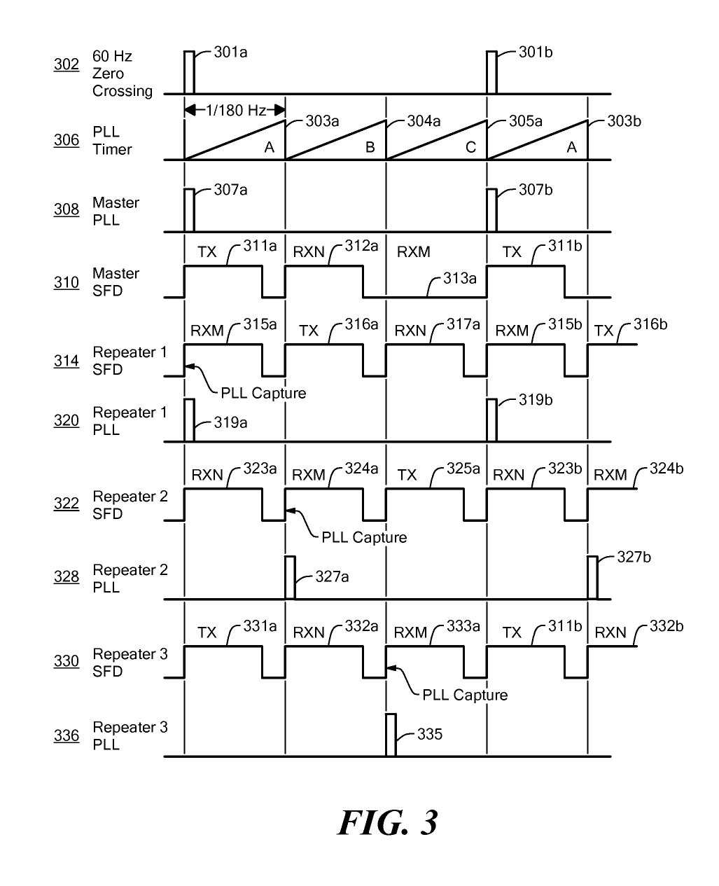

FIGS. 2 and 3 illustrate timing diagrams for the master PLL 110, the repeaters 118a-118g, and the EAS units 120a-120g, including how the repeaters 118a-118g and EAS units 120a-120g process the synchronization information and perform data reception/transmission during operation of the system 100 illustrated in FIG. 1.

According to one embodiment, the EAS units 120a-120g may be coupled to 60 Hz three phase power grids and may operate at 180 Hz, for example. Alternatively, systems may be coupled to 50 Hz three phase power grids and may operate at 150 Hz, among other frequencies. At 60 Hz, for example, the synchronization master radio 106 may transmit data packets containing 127 bytes in approximately 4 msec, with the packets being spaced apart in time by 16.6 msec. The repeaters 118a-118g may be configured to transmit or receive data approximately every 5.56 msec (16.6 msec/3) at 60 Hz, for example, which provides approximately 1.5 msec to process the data after receipt. One of ordinary skill in the art readily understands that other data packet sizes and data transmission rates may be used without departing from the spirit of the invention. Several factors control the actual possible length of the data packet. For example, with a 180 Hz frequency, the total time available for a data packet and processing is a 1/180 period. Processing may include determining from information coded in the packet header whether to pass the packet upstream or downstream. This decision may occur in the transmission (TX) time slot discussed with reference to FIG. 3 below.

FIG. 2 provides a timing diagram for the EAS units 120a-120g and illustrates one phase of a three phase 60 Hz sinusoidal power line signal 201 at 202. Pulses 203a-203c are positioned at positive going zero crossings of a 60 Hz sinusoidal power line signal 201 as illustrated at 204. The PLL output waveform 208 has a 180 Hz frequency with three signals 205a, 206a, 207a produced for one period of the sinusoidal power line signal 201. According to one embodiment, the EAS unit represented at 210 includes a PLL that is phase locked to the power line zero crossing pulses 203a-203c and generates pulses at 180 Hz frequency. During an initial 180 Hz period, the EAS unit transmits an interrogation signal 211a for a short period of time and then listens for a tag signal at 212a. During a second 180 Hz period, the EAS unit performs no actions during a short time period 213a that corresponds to the interrogation transmitter signal transmission 211a in the first 180 Hz period and then measures background noise at 214a corresponding to the period of listening for the tag signal 212a in the initial 180 Hz period. This pattern is repeated as illustrated at 210. Over a time period corresponding to two periods of the 60 Hz sinusoidal power line signal 201, the EAS system may transmit an interrogation signal three times, may listen for a tag signal three times, and may measure the background noise three times. The system therefore operates at an effective rate of 90 Hz. The EAS unit transmits interrogation signals along the PLL waveform 208 during phase A corresponding to 205a, phase C corresponding to 207a, and phase B corresponding to 206b, and measures background noise during phase B corresponding to 206a, phase A corresponding to 205b, and phase C corresponding to 207b. This pattern is repeated as illustrated in 208.

The EAS units may be provided on a three phase power grid. As illustrated at 216, the interrogation signal 219a for other EAS units in the system 100 will align with periods where the EAS units are performing no actions 213a. In other words, as illustrated at 216, the other EAS unit transmits interrogation signals along the PLL waveform 208 during phase B corresponding to 206a, phase A corresponding to 205b, and phase C corresponding to 207b and measures background noise during phase B corresponding to 205a, phase C corresponding to 207a, and phase B corresponding to 206b. This pattern is repeated as illustrated in 208. Alternatively, the other EAS unit may align with the timing illustrated at 210. The invention controls the interrogation signals of the EAS units 120a-120g so that the interrogation signals are not transmitted when the EAS units are receiving tag signals or measuring background noise. The EAS units 120a-120g are controlled to enable synchronization when a common power grid is not available to a plurality of systems, such as individual stores having independent generators.

According to the invention, the master radio transmitter/receiver 112, the local radio transmitter/receiver 130, the repeaters 118a-118g, and/or the remote PLLs 116a-116g are configured to control a timing of transmit and receive windows, as well as to synchronize the transmit and receive windows of one or more EAS units 120a-120g. The timing control and synchronization of EAS units 120a-120g may be performed using wired media 104 or wireless media 102. Alternatively, as previously discussed with respect to system 100, the functions of the repeaters 118a-118g and the remote PLLs 116a-116g may be integrated with the EAS units 120a-120g.

FIG. 3 provides a timing diagram for the repeaters 118a-118g and illustrates pulses 301a and 301b positioned at zero crossings of a 60 Hz power line signal. The PLL output waveform 306 has a 180 Hz frequency with three signals 303a,304a,305a being produced for one period of the power line signal. According to one embodiment illustrated at 308, the master PLL 110 generates pulse signals 307a and 307b that are phase locked to the power line zero crossing pulse signals 301a and 301b.

According to one embodiment, the master radio 112 may send and receive signals at a 60 Hz repetition rate. As illustrated in diagram 310, a master start of frame delimiter (“SFD”) is generated, having three time slots, when the master radio 112 starts to transmit a data packet or to receive a data packet. The master PLL 110 controls the radio transmission so that the SFD precisely aligns with the PLL clock. A transmission (“TX”) window 311a corresponds in duration to signal 303a, an upstream receive (“RXN”) window 312a corresponds in duration to signal 304a, and a downstream receive (“RXM”) window 313a corresponds in duration to signal 305a. The master TX window 311a allows the synchronization master radio 106 to transmit data. The master RXN window 312a is provided to capture data packets originating from downstream devices that are addressed to the synchronization master radio 106. The data arriving during the RXN window 312a may include information from one or more EAS units 120a-120g. The master RXM window 313a is shown without a signal amplitude because the synchronization master radio 106 is the furthest upstream device in system 100 and therefore is not able to capture data packets originating from an upstream device. This pattern is repeated as illustrated in 310. One of ordinary skill in the art will readily appreciate that greater or fewer time slots may be employed.

As illustrated in diagrams 314,322,330, the Repeaters 1,2,3 may generate a start of frame delimiter (“SFD”) and/or interrupt upon identifying a start of an incoming data packet. Diagrams 314 and 320 correspond to Repeater 1, which is immediately downstream of the synchronization master radio 106. As illustrated in diagrams 310 and 314, the Repeater 1 SFD is generated at approximately the same instant as the SFD for the synchronization master radio 106. While signal propagation and receiver bandwidth delay may introduce a slight time delay for generating the Repeater 1 SFD, applying the Repeater 1 SFD to control the Repeater 1 PLL results in the master PLL signal 307a and the Repeater 1 PLL signal 319a being approximately in synchronization.

A downstream receive (“RXM”) window 315a corresponds in duration to signal 303a, a transmission (“TX”) window 316a corresponds in duration to signal 304a, and an upstream receive (“RXN”) window 317a corresponds in duration to signal 305a. The RXM window 315a is provided to capture data packets originating from upstream devices, including the synchronization master radio 106, and addressed to the Repeater 1 and/or a downstream device. The data arriving during the RXM window 313a may include synchronization information for the EAS units 120a-120g. The TX window 316a allows for data transmission. The RXN window 317a is provided to capture data packets originating from downstream devices and addressed to the Repeater 1 and/or an upstream device, including the synchronization master radio 106. The data arriving during the RXN window 312a may include information from the EAS units 120a-120g. This pattern is repeated as illustrated in 314.

Diagrams 322 and 328 correspond to Repeater 2, which is immediately downstream of Repeater 1. As illustrated in diagrams 314 and 322, the Repeater 2 SFD is generated one period or 180 Hz after the Repeater 1 SFD. Applying the Repeater 2 SFD to control the Repeater 2 PLL results in the Repeater 1 PLL signal 319a and the Repeater 2 PLL signal 327a being one period or 180 Hz apart in synchronization.

A downstream receive (“RXM”) window 324a corresponds in duration to signal 304a, a transmission (“TX”) window 325a corresponds in duration to signal 305a, and an upstream receive (“RXN”) window 323b corresponds in duration to signal 303b. The RXM window 324a is provided to capture data packets originating from upstream devices, including the synchronization master radio 106 and/or Repeater 1, and addressed to the Repeater 2 and/or a downstream device. The data packet arriving during the RXM window 324a may include synchronization information for the EAS units 120a-120g. The TX window 325a allows for data transmission. The RXN window 323b is provided to capture data packets originating from downstream devices and addressed to the Repeater 2 and/or an upstream device, including the synchronization master radio 106 and/or the Repeater 1. The data arriving during the RXN window 323b may include information from the EAS units 120a-120g. This pattern is repeated as illustrated in 322.

Diagrams 330 and 336 correspond to Repeater 3, which is immediately downstream of Repeater 2. As illustrated in diagrams 322 and 330, the Repeater 3 SFD is generated one period or 180 Hz after the Repeater 2 SFD. Applying the Repeater 3 SFD to control the Repeater 3 PLL results in the Repeater 2 PLL signal 327a and the Repeater 3 PLL signal 335 being one period or 180 Hz apart in synchronization.

A downstream receive (“RXM”) window 333a corresponds in duration to signal 305a, a transmission (“TX”) window 331b corresponds in duration to signal 303b, and an upstream receive (“RXN”) window 332b corresponds in duration to signal 304b. The RXM window 333a is provided to capture data packets originating from upstream devices, including the synchronization master radio 106, Repeater 1 and/or Repeater 2, and addressed to the Repeater 3 and/or a downstream device. The data arriving during the RXM window 333a may include synchronization information for the EAS units 120a-120g. The TX window 331b allows for data transmission. The RXN window 332b is provided to capture data packets originating from downstream devices and addressed to the Repeater 3 and/or an upstream device, including the synchronization master radio 106 Repeater 1 and/or the Repeater 2. The data arriving during the RXN window 332b may include information from the EAS units 120a-120g. This pattern is repeated as illustrated in 330.

According to one embodiment, multiple layers of downstream repeaters may be synchronized to operate within a few microseconds, or other time period, of each other. The system 100 provides carrier level synchronization by associating the remote PLLs 116a-116g with one or more corresponding EAS units 120a-120g. The EAS units 120a-120g are controlled by the repeaters 118a-118g to transmit interrogation signals during time periods when other EAS units 120a-120g are transmitting information or expecting to transmit information. The invention allows EAS units 120a-120g that do not share a common power source to act in concert to cover one or more interrogation zones, without creating major interference or noise generation.

According to one embodiment, the transmission from deactivator devices (not shown) in the system can be synchronized with the various EAS units 120a-120g in the same manner as described above so as not to degrade system performance. It is understood that the deactivator devices may be implemented and coupled within the system 100 at any place the EAS unit 120a-120g may be implemented. In other words, for purposes of the present invention, the EAS units 120a-120g shown in the drawing figures can be deactivators. Of note, although the present invention is described with reference to a 60 Hz system, it is understood that the present invention can be implemented using another base frequency, e.g., 50 Hz.

The present invention advantageously provides and defines a comprehensive system and method for implementing a wireless synchronization of transmit and receive signals and data communication across the EAS units 120a-120g. The present invention further advantageously provides and defines a comprehensive system and method for implementing a wireless synchronization of transmit and receive signals and data communication across the EAS units 120a-120g using synchronization devices having PLLs. The present invention enables the communication components to provide data communication by the EAS units 120a-120g during idle periods of the synchronization signal transmission.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general-purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method of synchronizing a plurality of electronic article surveillance (“EAS”) units and providing wireless data transfer by the EAS units, the method comprising:
generating a master synchronization signal;
transmitting the master synchronization signal to the plurality of EAS units;
applying the master synchronization signal to trigger a synchronization packet reception period;
calculating a start of a wireless data transfer period based on the triggering of the synchronization packet reception period; and
triggering the start of the wireless data transfer period.

2. The method of claim 1, further comprising receiving the master synchronization signal at a repeater.

3. The method of claim 2, further comprising calculating a start of downstream synchronization signal transfer based on the master synchronization signal and transmitting the downstream synchronization signal to the EAS units.

4. The method of claim 3, wherein the downstream synchronization signal is wirelessly transmitted.

5. The method of claim 1, further comprising using a wireless secondary synchronization master to relay the master synchronization signal.

6. The method of claim 5, further comprising delaying the relay of the master synchronization signal by a delay period.

7. The method of claim 6, wherein the delay period is a multiple of 1/180 Hz.

8. A system for synchronizing the operation of a plurality of EAS units and providing wireless data transfer by the EAS units, the system comprising:
a synchronization master, the synchronization master including:
a master phase-locked loop generating a master synchronization signal;
a master radio transmitter transmitting the master synchronization signal; and
a master radio receiver receiving data originating from the EAS units.

9. The system of claim 8, further comprising a plurality of synchronization receivers, at least one of the plurality of synchronization receivers receiving the master synchronization signal from the synchronization master.

10. The system of claim 9, wherein the at least one of the plurality of synchronization receivers includes a synchronization phase-locked loop that generates a trigger signal from the master synchronization signal, the trigger signal being applied to start reception of synchronization information.

11. The system of claim 10, wherein the trigger signal defines a time period for transmitting synchronization information to at least one of the plurality of EAS units.

12. The system of claim 11, wherein the trigger signal defines a time period for transmitting packet data by the plurality of EAS units using a wireless communication link.

13. The system of claim 11, wherein the trigger signal defines a time period for transmitting packet data by the plurality of EAS units using a wired communication link.

14. The system of claim 8, further including a secondary synchronization master, the secondary synchronization master relaying the master synchronization signal to at least one EAS unit.

15. The system of claim 14, wherein the secondary synchronization master includes a secondary master phase-locked loop for synchronizing to the master synchronization signal.

16. The system of claim 15, wherein the secondary synchronization master transmits the master synchronization signal to the at least one additional EAS unit that is positioned out of communication range with the synchronization master.

17. An EAS system, comprising:
a repeater receiving a synchronization signal and generating a pattern of receiving time periods and transmitting time periods based on the synchronization period; and
an EAS unit in communication with the repeater, the EAS unit arranged to communicate during the receiving time periods and the transmitting time periods.

18. The system of claim 17, wherein the EAS unit is configured to perform at least one of transmitting data and interrogating an EAS marker by transmitting interrogation signals during the receiving time periods and the transmitting time periods.

19. The system of claim 17, wherein the EAS system is a secondary master, wherein the secondary master relays the synchronization signal to additional EAS systems.

20. The system of claim 19, wherein the secondary master relays the synchronization signal to additional EAS systems.
